(19) United States
(12) Patent Application Publication
(10) Pub. No.: US 2004/0073386 A1
(43) Pub. Date: Apr. 15, 2004

(54) Method for estimating fuel volume in a motor vehicle tank

(76) Inventor: Nicolas Benedetti, Saint-Cloud (FR)

Correspondence Address: LARSON & TAYLOR, PLC, 1199 NORTH FAIRFAX STREET, SUITE 900, ALEXANDRIA, VA, 22314, US

(21) Appl. No.: 10/432,013

(22) PCT Filed: Nov. 20, 2001
(86) PCT No.: PCT/EP01/13566

(30) Foreign Application Priority Data
Nov. 20, 2000 (FR) 00/14946

(51) Int. Cl. G06F 19/00

(52) U.S. Cl. 702/55

(57) ABSTRACT

Method of estimating the volume of fuel in the tank of a motor vehicle, in which a measurement of the level of the fuel in the tank is made using a level sensor, this level sensor constituting a first information source whose signal is disturbed by a scale factor depending on values other than the level of the fuel, in particular the temperature, n other information sources are used relating to n different values other than the fuel level and making it possible to make the scale factor observable and the results provided by the (n+1) information sources are processed in order to estimate the scale factor, n being an integer greater than or equal to 1, according to which use is made of a second information source capable of providing information relating to the flow rate of the fuel consumed by the vehicle.

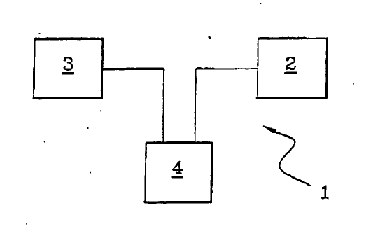

The present invention relates to a method of estimating the volume of fuel in the tank of a motor vehicle.

Many devices have been proposed for measuring the level of fuel in the tank of a motor vehicle.

These known devices generally use level gauges or sensors delivering a signal representative of the level of the fuel in the tank.

The French patent application FR-A-2 746 500 describes a level gauge comprising an ultrasonic transducer disposed in the bottom of the tank. This transducer transmits pulses that are reflected by the interface between the liquid and the air. By measuring the elapsed time between the transmission and reception of a pulse and knowing the speed of sound in the fuel, it is possible to calculate the height of the fuel in the tank. However, the speed of sound varies as a function of the density of the fuel which depends, in particular, on temperature, which introduces an error in the results. In order to correct this error, the tank comprises reflectors immersed in the fuel and that are capable of reflecting the pulses. A comparison between the pulses reflected respectively by the surface of the fuel and by the reflectors makes it possible to calculate the height of the fuel in the tank.

The European patent application EP-A-0 927 877 describes a level gauge or sensor comprising an electrical capacitor used for measurement and an electrical capacitor used as a reference. The capacitor used for measurement comprises two plates between which the fuel can fall and rise, thus modifying the permittivity between the plates. The capacitor used as a reference is permanently immersed in the fuel and provides a reference value of the dielectric constant of the fuel. An adapted electronic circuit determines the level of the fuel in the tank.

There is a requirement to simplify the fuel level measuring devices, whilst obtaining a small error in the estimation of the volume of fuel.

The present invention aims to meet this requirement in particular.

It achieves this by means of a new method of estimating the volume of fuel in the tank of a motor vehicle, in which a measurement of the level of the fuel in the tank is made using a level sensor (2) capable of delivering a signal representative of the level of the fuel in the tank, this level sensor constituting a first information source and this signal being disturbed by a scale factor depending on at least one value other than the level of the fuel, in particular the temperature C, n other information sources are used relating to n different values other than the fuel level and malting it possible to make the scale factor observable and the results provided by the (n+1) information sources are processed in order to estimate the scale factor, n being an integer greater than or equal to 1, according to which use is made of a second information source capable of providing information relating to the flow rate of the fuel consumed by the vehicle.

The information provided by the said n other information sources makes it possible to correct to a certain degree the error present in the signal delivered by the level sensor, which makes it possible to obtain the sought accuracy.

Because of the invention, it is possible to avoid having recourse to a sensor serving as a reference or to immersed reflectors and the manufacture of the tank is thereby simplified.

The invention also has the advantage of indifferently allowing the use of capacitive, ultrasonic, pressure measuring or other level sensors.

According to the invention, use is made of a second information source capable of providing information relating to the flow rate of the fuel consumed by the vehicle.

This consumed fuel flow rate can be given, for example, by a computer associated with the engine of the vehicle.

Advantage is thus taken, without notable additional cost, of information already available or easily available on the vehicle.

In a particularly advantageous embodiment of the invention, the scale factor is estimated by assuming, as a hypothesis, that the measured fuel level is related to the real level by an equation of the following type:

z=(1+fₑ₁+fₑ₂(T−T₀)).x+b

z being the indication of level given by the level sensor,

x being the real level of the fuel,

fₑ₁ being the component of the scale factor that is independent of the temperature,

fₑ₂ being the component of the scale factor that is dependent on the temperature,

T being the temperature in the tank in the vicinity of the sensor,

T₀ being the reference temperature,

b being a measurement noise.

The scale factor is then determined by means of estimating a state vector, having as components the level of the fuel, the values relating to the n other information sources and the scale factor, by means of an algorithm making use of the estimators of the maximum probability, of the minimum variance, of the a posteriori maximum or any other Bayesian process, for example.

In a particular embodiment of the invention, a Kalman filter is used for estimating the aforesaid vector.

The invention also relates to a device for estimating the volume of fuel in the fuel tank of a motor vehicle, characterized in that it comprises:

a level sensor capable of delivering a signal representative of the level of the fuel in the tank, this level sensor constituting a first information source, this signal being disturbed by a scale factor depending on at least one value other than the fuel level,

n information sources each capable of delivering a signal representative of a value other than the fuel level, in particular an information source capable of delivering a signal representative of the flow rate of fuel consumed by the vehicle, and

a processing unit designed to combine the signals delivered by the (n+1) information sources in such a way as to estimate the scale factor and to correct the signal delivered by the level sensor and thus to obtain an indication of the volume of fuel that is closer to reality.

One of the information sources can be located at the level of the engine of the vehicle, for example, and can be constituted for example by a computer associated with the engine, delivering information relating to the flow rate of fuel consumed by the engine.

The invention will be better understood on reading the following detailed description of a non-limitative example embodiment of the invention and on examining the appended diagram.

On the drawing there has been shown, in a highly diagrammatic manner, a device 1 for estimating the volume of fuel in the tank of a motor vehicle.

This device 1 comprises a level sensor 2, of any known type, constituting a first information source, capable of delivering a signal representative of the level of fuel in the tank, a second information source 3 capable of delivering information relating to the flow rate of fuel consumed by the engine and a processing unit 4.

The level sensor 2 can for example comprise, in a known way, a capacitor, a potentiometer or an ultrasonic transducer.

The second information source 3 can for example be present at the level of the engine and the information relating to the quantity of fuel consumed can be delivered by the computer associated with the engine.

The level sensor 2 delivers a signal marred by a certain error, partly related to dispersions in the characteristics of the fuel and to variations in the environmental parameters of the tank, in particular the temperature.

Temperature has an important role, in particular because the electrical properties of the fuel, its density and the pressure in the tank depend on temperature.

In the described example, it is assumed that the signal delivered by the level sensor 2 is related to the real level by an equation of the following type;

z=(1+fₑ₁+fₑ₂(T−T₀)).x+b

z being the indication of level given by the level sensor 2,

x being the real level of the fuel,

fₑ₁ being the component of the scale factor that is independent of the temperature,

fₑ₂ being the component of the scale factor that is dependent on the temperature,

T being the temperature in the tank in the vicinity of the sensor,

T₀ being the reference temperature,

b being a measurement noise.

The scale factor and the measurement noise characterize the error in the level indication delivered by the level sensor 2.

The signal delivered by the level sensor 2 and the flow rate information are sent to the processing unit 4, which estimates the scale factor and the volume of fuel on the basis of a hybridization of the measurements.

It is assumed that the system is governed by two equations.

The first equation described the evolution of the system over time and theoretically makes it possible to know the status of the system at any time.

This evolution equation is of the following form:

dx/dt=F.x+v

x is the state vector, the status of a system being all of the variables fully describing the past of the system, these variables being brought together in a vector,

F is the evolution matrix of the system,

v is the measurement noise, assumed to be white, Gaussian and centred.

The second equation is an observation equation, relating the state vector to a measurements vector.

It has the following form:

z=G.x+w

z being the measurements vector,

G being the observation mats,

w being a measurement noise, assumed to be white, Gaussian and centred.

In the described example, the measurements vector z is a two-dimensional vector whose components are the signal delivered by the level sensor 2 and the flow rate information.

The components of the state vector x are the volume of fuel, the flow rate of fuel consumed and the scale factor.

The processing unit 4 estimates the real volume of the fuel by means of an adapted algorithm.

Those skilled in the art will understand that the flow rate information makes it possible to make the scale factor observable, and therefore to estimate the real volume of fuel.

The estimation of the volume, the flow rate and the scale factor is cared out in the described example by means of a Kalman filter.

The latter is the estimator of the minimum variance and provides an estimation of the state vector x at all times by the solving a set of recurrent equations by minimizing the following quadratic deviation criterion:

E[(x−x′)(x−x′)^{T}]

x being the state vector,

x′ being the estimated state vector.

The algorithm used makes it possible to obtain a corrected value of the volume of fuel, on the basis of the knowledge of the flow rate of fuel consumed by the engine and of the level measured by means of the level sensor 2.

The invention is not of course limited to the example embodiment that has just been described.

In particular, the Kalman filter can be replaced by other estimation techniques, for example any Bayesian process.

It is also possible to choose a value different from that of the flow rate of the fuel consumed by the engine for the value serving as the information source 3.

It is also possible to carry out a hybridization of n² different measurements.

1. Method of estimating the volume of fuel in the tank of a motor vehicle, in which a measurement of the level of the fuel in the tank is made using a level sensor (2) capable of delivering a signal representative of the level of the fuel in the tank, this level sensor constituting a first information source and this signal being disturbed by a scale factor depending on at least one value other than the level of the fuel, in particular the temperature (M), n other information sources are used relating to n different values other than the fuel level and malting it possible to make the scale factor observable and the results provided by the (n+1) information sources are processed in order to estimate the scale factor, n being an integer greater than or equal to 1, characterize in that use is made of a second information source capable of providing information relating to the flow rate of the fuel consumed by the vehicle.

2. Method according to the preceding claim characterized in that the flow rate of fuel consumed is given by a computer associated with the engine of the vehicle.

3. Method according to any one of the preceding claims, characterized in that the scale factor is estimated by assuming, as a hypothesis, that the measured fuel level is related to the real level by an equation of the following type:
z=(1+fₑ₁+fₑ₂(T−T₀)).x+b
z being the indication of level given by the level sensor,
x being the real level of the fuel,
fₑ₁ being the component of the scale factor that is independent of the temperature,
fₑ₂ being the component of the scale factor that is dependent on the temperature,
T being the temperature in the tank in the vicinity of the sensor,
T₀ being the reference temperature,
b being a measurement noise.

4. Method according to any one of the preceding claims, characterized in that a state vector is estimated, having as components the level of the fuel, the values relating to the n other information sources and the scale factor, by means of an algorithm making use of the estimators of the maximum probability, of the minimum variance, of the a posterori maximum or of a Bayesian process.

5. Method according to the preceding claim, characterized in that a Kalman filler is used for estimating the said state vector.

6. Device (1) for estimating the volume of fuel in the fuel tank of a motor vehicle, characterized in that it comprises:
a level sensor (2) capable of delivering a signal representative of the level of the fuel in the tank, this level sensor constituting a first information source, this signal being disturbed by a scale factor depending on at least one value other than the fuel level.
n information sources each capable of delivering a signal representative of a value other than the fuel level, in particular an information source capable of delivering a signal representative of the flow rate of fuel consumed by the vehicle, and
a processing unit (4) designed to combine the signals delivered by the (n+1) information sources in such a way as to estimate the scale factor and to correct the signal delivered by the level sensor and thus obtaining an indication of the volume of fuel that is closer to reality.

7. Device according to the preceding claim, characterized in that one of the information sources delivers information relating to the flow rate of fuel consumed by the engine.
